(19) United States
(12) Patent Application Publication
(10) Pub. No.: US 2008/0202126 A1
(43) Pub. Date: Aug. 28, 2008

(54) FISH FRIENDLY LNG VAPORIZER

(76) Inventor: GERALD E. ENGDAHL, Wheaton, IL (US)

Correspondence Address: GERALD ENGDAHL, 1425 OXFORD LANE, WHEATON, IL, 60187, US

(21) Appl. No.: 12/024,398

(22) Filed: Feb. 1, 2008

Related U.S. Application Data
(60) Provisional application No. 60/889,282, filed on Feb. 11, 2007.

(51) Int. Cl. F17C 9/02

(52) U.S. Cl. 62/50.2

(57) ABSTRACT

The new liquefied natural gas (LNG) vaporizer uses seawater as a heat source for vaporizing in a fish friendly manner. The vaporizer provides environmental benefits.

Multiple seawater heat source plate heat transfer surface units provide heat for vaporizing propane. Propane provides the heat source for LNG vaporization in a propane/LNG exchanger.

### RELATED APPLICATIONS

This application claims domestic priority from provisional application No. 60/889,282 filed on Feb. 11, 2007.

### TECHNICAL FIELD

The present field relates to the vaporization of liquefied natural gas (LNG) using seawater as the heat source and being fish friendly.

### BACKGROUND

These are significant quantities of natural gas Worldwide which are located away from a natural gas market. Transporting the natural gas by pipeline is one method of transporting the gas to market. Another method utilized when pipelines are not feasible, is to liquefy the gas and transport the liquefied natural gas (LNG) to market in the liquid state. The LNG is typically transported in ships constructed specifically for transporting the LNG. The LNG is offloaded from the ships into large LNG storage tanks which are part of a LNG import terminal. At the terminal, the liquid LNG is pumped to pipeline pressure, vaporized and sent to the pipeline for distribution. An alternate arrangement would include vaporizing the LNG onboard the LNG transport ship. The vaporized LNG would flow via pipeline from the ship to land based facilities. Another arrangement includes vaporization facilities located offshore.

There are several benefits in using seawater as the heat source for vaporizing LNG. However, the use of seawater as a heat source for vaporizing LNG can have a negative impact on fish species.

U.S. Pat. No. 6,089,022 (Zednik et al.) discloses a seawater heat source LNG vaporization system positioned on ships. Seawater taken from the body of water surrounding the ship flows through a vaporizer to heat and vaporize the LNG back into natural gas before the natural gas is directed to onshore facilities. Pumped seawater is used as the heat source for LNG vaporization.

Zednik et al. furthermore cites the “TRI-EX” intermediate fluid LNG vaporizer as one vaporizer type capable of using seawater as the heat source for vaporizing LNG. This intermediate fluid vaporizer is disclosed in several U.S. patents. U.S. Pat. No. 6,164,247 is an intermediate fluid vaporizer with special provisions for maintaining the intermediate fluid liquid level. The heat source fluid (seawater) flows through several tube and channel arrangements. U.S. Pat. No. 6,367,429 is an intermediate fluid vaporizer with the heat source fluid flowing through two or more tube passes. As in U.S. Pat. No. 6,164,247 the heat source fluid inlet pressure must be greater than the pressure loss of the fluid flowing through several set of tubes. Pumping of the seawater is required.

U.S. Pat. No. 6,945,049 is a complete closed coolant circuit shipboard regasification system including a LNG/coolant heat exchanger, a natural gas/steam heat exchanger and means to control the evaporated coolant pressure.

U.S. Pat. Nos. 6,598,408 and 6,688,114 disclose an improved LNG carrier having on board regasification with an intermediate fluid circulating between the LNG vaporizer and at least two sources of heat, and one or more pumps for circulating the intermediate fluid between the vaporizer and the sources of heat.

Another type of seawater heat source vaporizer is called the open rack vaporizer (ORV). The ORV consists of vertical aluminum panels with LNG passages. Pumped seawater is directed to flow vertically downward as a falling film over the aluminum panels to directly vaporize LNG. The aluminum panels are not submerged.

These seawater LNG vaporizers are not fish friendly. Accordingly, a need exists for a fish friendly seawater heat source LNG vaporizer with environmental benefits.

### OBJECTIVES

Several objectives of this patent follow:

To provide a seawater heat source LNG vaporizer which is fish friendly.

To provide a seawater heat source LNG vaporizer which has environmental benefits.

To provide energy efficient, high heat transfer rate arrangement to reliably vaporize LNG.

### SUMMARY OF THE INVENTION

The invention discloses a seawater heat source LNG vaporizer which is fish friendly. The seawater heat source LNG vaporizer provides environmental benefits.

In accordance with one aspect of the invention, a seawater heat source heat exchanger with the heat source seawater not being pumped, where heat source seawater flow is obtained via natural means, air moving device means and combinations of these, and the seawater heat source heat exchanger providing at least a portion of heat for LNG vaporization.

In accordance with another aspect of the invention, a seawater heat source heat exchanger with a seawater side in heat exchange with seawater, and a fluid side, the heat source seawater flowing generally adjacent to the seawater side, the heat source seawater not being pumped, the fluid side having at least a portion vapor, and the seawater heat source heat exchanger providing at least a portion of heat for LNG vaporization.

In accordance with another aspect of the invention a seawater heat source LNG vaporizer with multiple plate heat transfer surface units containing and vaporizing at least a portion of propane flowing within said plate heat transfer surface units, said plate heat transfer surface units in heat exchange with seawater, seawater flowing generally adjacent to said plate heat transfer surface units, said plate heat transfer surface units providing at least a portion of heat for LNG vaporization, at least one propane/LNG exchanger providing at least a portion of heat for vaporizing LNG, and at least one conduit communicating the plate heat transfer surface units with the propane/LNG exchanger, said conduit arranged for propane flow.

In accordance with another aspect of the invention a seawater heat source heat exchanger with plate heat transfer surface units in heat exchange with seawater containing and vaporizing at least a portion of the propane flowing within said plate heat transfer surface units, each plate heat transfer surface unit with at least one unit inlet header and at least one unit outlet header, at least one propane inlet manifold communicating and distributing propane to said inlet headers, at least one propane outlet manifold communicating with said unit outlet headers, at least one propane separator communicating with said propane outlet manifold and providing a separator liquid propane stream and a separator propane vapor stream, said separator propane vapor stream providing at least a portion of heat for LNG vaporization, and a propane pump communicating with said separator liquid propane stream providing a pump discharge stream, and at least a portion of pump discharge stream being routed to said propane inlet manifold.

In further accordance with another aspect of the invention, a plate heat transfer surface cleaning apparatus including trackage, at least one trackage carriage, at least one traveling cleaning head, power and control cables and tubing delivering cleaning material for the cleaning apparatus, wherein the apparatus is configured for cleaning at least a portion of the plate heat transfer surface.

In further accordance with yet another aspect of the invention, a seawater heat source LNG vaporizer comprising improvements from the group: where the heat source seawater flow is obtained without seawater pumps, where heat source seawater flow is obtained via natural means, air moving device means and combinations of these, where river water, brackish water and other waters provide a heat source, and where the seawater heat source LNG vaporizer is fish friendly.

In further accordance with yet another aspect of the invention, a seawater heat source heat exchanger comprising improvements from the group: where the seawater heat source heat exchanger is a plate heat transfer surface unit, where the seawater heat source heat exchanger is an arrangement of tubes, where seawater pumps are used for some purpose, where river water, brackish water and other waters provide a heat source, where the fluid side is all vapor, all liquid or a combination of vapor and liquid, where heat source seawater flow is obtained via natural means, air moving device means and combinations of these, where the seawater heat source heat exchanger is fish friendly, where the heat source seawater flow is obtained without seawater pumps, and where inlet header propane flow is provided in excess of that vaporized in the plate heat transfer surface unit,

### BRIEF DESCRIPTION OF THE DRAWINGS

The operation and advantages of the present invention will be better understood by referring to the drawings, not necessarily to scale, in which like numerals identify like parts and in which:

FIG. 1 is an elevation view diagram of a seawater heat source LNG vaporizer.

FIG. 2 is a plan view section diagram of a LNG vaporizer.

FIG. 3 is a side elevation view flow sketch of a seawater heat source LNG vaporizer.

FIG. 4 is a plan view diagram of a seawater heat source LNG vaporizer with air moving devices.

FIG. 5 is an elevation view diagram of a seawater heat source LNG vaporizer air moving device.

FIG. 6 is an elevation view diagram of a plate heat transfer surface unit with vertical cleaner trackage.

FIG. 7 is an elevation view diagram of vertical and horizontal cleaner trackage of a plate heat transfer surface unit cleaning system.

FIG. 8 is an elevation view diagram of an offshore support structure for a seawater heat source LNG vaporizer.

FIG. 9 is an elevation view diagram of a weather shield supported seawater heat source LNG vaporizer.

FIG. 10 is an elevation view diagram of an offshore platform supporting a seawater heat source LNG vaporizer.

FIG. 11 is an elevation view diagram of the end of a jetty supporting a seawater heat source LNG vaporizer.

### DETAILED DESCRIPTION OF THE INVENTION

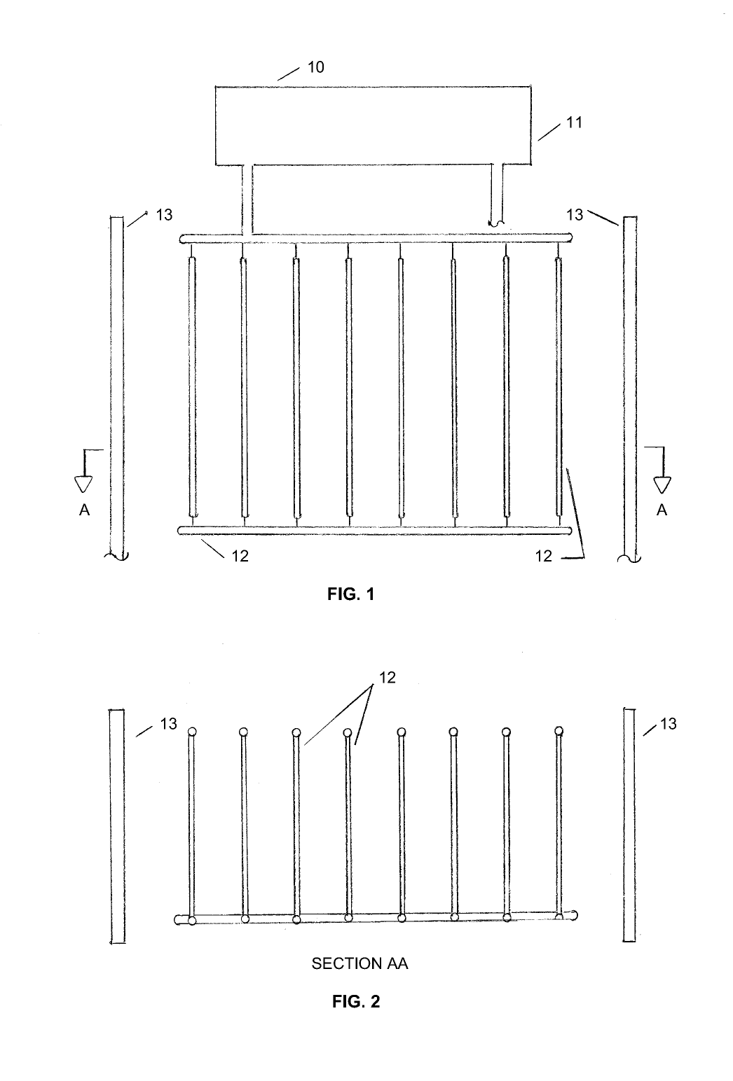

The LNG vaporizing system in FIG. 1 illustrates a seawater heat source LNG vaporizer 10. The system of FIG. 1 includes a LNG/propane exchanger 11 and plate heat transfer surface units 12. The plate heat transfer surface units 12 are submerged or mostly submerged with the seawater flowing generally adjacent to the plate heat transfer surface units. The LNG/propane exchanger 11 can be a shell and tube exchanger, a printed circuit heat exchanger or another type of exchanger to vaporize LNG with a propane heat source. Propane is vaporized in the plate heat transfer surface units 12. The plate heat transfer surface units 12 can be constructed of materials selected to retard marine growth. Each seawater plate heat transfer surface unit 12 consists of multiple plate heat transfer surface parts connected together. Each plate heat transfer surface part includes at least one propane heat transfer circuit. The plate heat transfer surface part is available from the Paul Muller Company of Springfield, Mo. and is known as the “TEMP-PLATE”. One arrangement of the plate heat transfer surface unit 12 would include ten “TEMP-PLATE” parts each measuring about 5 ft by 25 ft and connected on the long side to shape a plate heat transfer surface unit 12 with a vertical height of about 50 ft and a width of about 25 ft. Many other plate configurations can be utilized to develop the plate heat transfer surface unit 12. Heat source seawater flows generally adjacent to the plate heat transfer surface units 12.

The seawater heat source LNG vaporizer 10 is shown with propane as the closed circuit fluid. Other fluids with suitable properties can be used in lieu of propane. The driving force for the circulation of the closed circuit fluid can be provided by the vaporization and condensation of the fluid or by a circulating pump. The closed circuit fluid can be heated, heated and vaporized, or vaporized using seawater as a heat source. The closed circuit fluid is cooled, condensed and cooled, or condensed in the LNG/propane exchanger.

Weather shields 13 can be located one on each side of the plate heat transfer surface units 12. The weather shields 13 are positioned generally parallel to the plate heat transfer surface units 12. The weather shields 13 are used to reduce the effects of weather on the plate heat transfer surface units 12. Cables or nets (not shown) can be strung between the weather shields 13 to prevent large fish or mammals from entering the space between the plate heat transfer surface units 12. The application may require the use of one weather shield, multiple weather shields, or no weather shields. The weather shield can have other functions in addition to reducing the effects of weather on the plate heat transfer surface units.

The seawater heat source LNG vaporizer 10 physical arrangements are designed to eliminate the impingement and impact physical stress to fish species. The seawater heat source LNG vaporizer 10 is designed to eliminate fish species entrainment. Operating without seawater heat source pumps eliminates the impingement and impact physical stress to fish species and fish species entrainment. The plate heat transfer surface wall temperatures in contact with fish are maintained above freezing to reduce fish species thermal stress. The temperature decrease of the heat source seawater as it flows adjacent to the plate heat transfer surface units is low to reduce fish species thermal stress.

FIG. 2 is plan views section A-A of the seawater heat source LNG vaporizer 10. The section shows the multiple plate heat transfer surface units 12 and the weather shields 13.

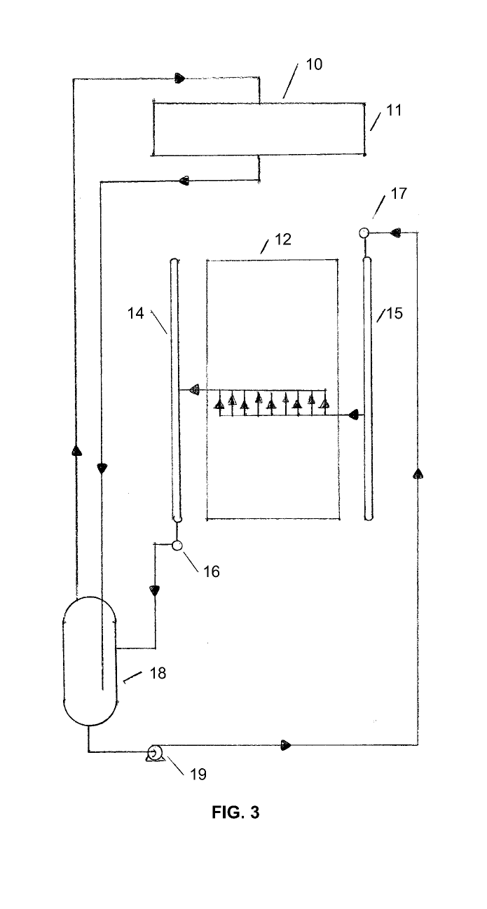

FIG. 3 is a side elevation view flow sketch of the seawater heat source LNG vaporizer 10. The flow sketch FIG. 3 includes the LNG/propane exchanger 11 and an individual plate heat transfer surface unit 12. Each plate heat transfer surface unit 12 includes multiple propane heat transfer circuits. Seawater in heat exchange with the plate heat transfer surface units provides heat for vaporizing a portion of the propane flowing within the heat transfer circuit. The FIG. 3 flow sketch includes one propane heat transfer circuit located within the plate heat transfer surface unit. Multiple propane heat transfer circuits would actually be included within each plate heat transfer surface unit 12 with connections typical of that shown in FIG. 3. A plate heat transfer surface outlet header 14 is connected to each individual plate heat transfer surface unit 12. A plate heat transfer surface inlet header 15 is connected to each individual plate heat transfer surface unit 12. The inlet header 15 and the outlet header 14 connect to each propane heat transfer circuit within each individual seawater plate heat transfer surface unit 12. An outlet manifold 16 communicates with several plate heat transfer surface unit outlet headers 14 and receives two phase propane flow from each outlet header 14. An inlet manifold 17 communicates with several plate heat transfer surface inlet headers 15 and provides liquid propane flow to each inlet header 15. Two phase propane flows from the outlet manifold 16 into a propane vapor/liquid separator 18. Propane vapor exits the propane separator 18 and is routed to the LNG/propane exchanger 11 as the heat source for LNG vaporization. Propane vapor is condensed in LNG/propane exchanger 11. Propane condensate from the LNG/propane exchanger 11 returns via a conduit to the propane separator 18. Propane condensate from LNG/propane exchanger 11 generally flows by gravity to propane separator 18, but propane flow to the separator could be via a propane pump (not shown). Liquid propane from propane separator 18 is routed via propane pump 19 to inlet manifold 17. The propane pump 19 is shown on the flow sketch as being located outside of the separator 18. An alternate arrangement would locate the pump 19 within separator 18. The propane pump 19 in either location would generally be of the submersible type. The propane heat transfer circuits function as an over-feed cycle.

The over-feed cycle is designed to feed liquid propane via the inlet header 15 in approximately equal quantities to the multiple propane heat transfer circuits within each individual plate heat transfer surface unit 12. A restriction means is included in the inlet to each heat transfer circuit to obtain the approximately equal distribution of liquid propane to each heat transfer circuit. The propane liquid flow entering each propane heat transfer circuit is greater than the propane being vaporized in the circuit. A portion of the liquid feed to each individual heat transfer circuit vaporizes as a result of heat transfer with the seawater. The propane outflow from each heat transfer circuit within each individual plate heat transfer surface unit 12 contains liquid and vapor. The two phase propane flows from each heat transfer circuit to outlet header 14 and flows to propane separator 18 via outlet manifold 16, completing the over-feed cycle. The over-feed cycle provides increased propane heat transfer with the seawater. The propane within each individual heat transfer circuit boils and vaporizes at approximately the same pressure. The pressure in the lower heat transfer circuit is about the same as the pressure in the upper heat transfer circuit within a plate heat transfer surface unit 12. Propane boiling at an increased pressure would have a lesser temperature difference with the seawater for heat transfer. The heating duty generated at increased propane pressure would be less. The over-feed cycle eliminates the requirement for each heat transfer circuit to operate with some form of control system.

An alternate vaporizer arrangement would include propane heat transfer circuits with out using the over-feed cycle. A propane heat transfer circuit control system would control the circuit inlet propane flow to obtain the desired propane outlet condition. Another vaporizer arrangement would include propane heat transfer circuits using the over-feed cycle and propane heat transfer circuits not using the over-feed cycle.

The control system of the seawater heat source LNG vaporizer 10 can include a LNG flow control loop controlling the flow of LNG through the LNG/propane exchanger 11. The LNG flow rate can be controlled from 100% of capacity to essentially zero flow. The LNG vapor discharge temperatures would approach the seawater temperature as the LNG flow is reduced. Controls can be added to maintain a more uniform vapor outlet temperature. The control system can accommodate fast vaporizer system startups and shutdowns. With the propane heat transfer circuits operational, the vaporizer is started by initiating LNG flow via the flow control loop. The system is shut down by closing the LNG flow control valve. The seawater heat source LNG vaporizer 10 is a simple system. The simple system is more reliable. The vaporizer has low maintenance requirements.

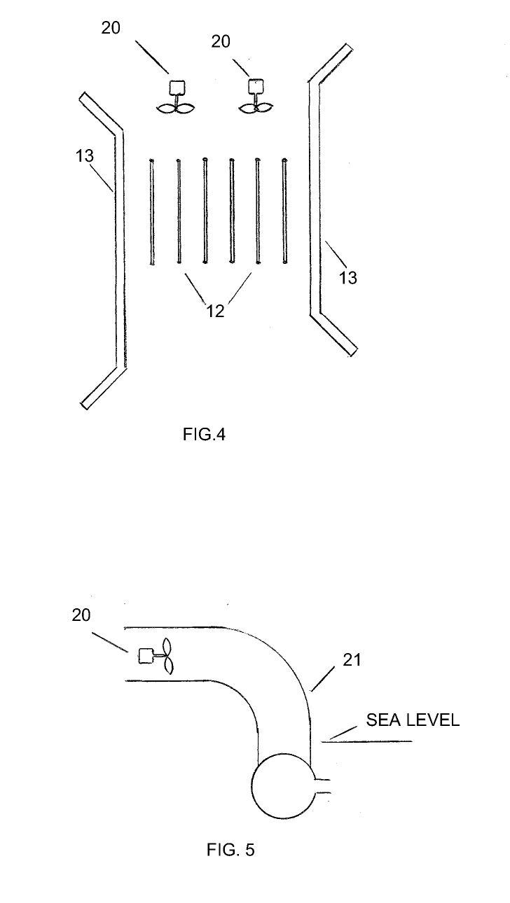

Heat source seawater flow is provided by natural seawater flow means or by air moving devices providing air source flow currents or by combinations of natural means and air moving device means. The natural seawater flow is provided by one or more means including currents, waves, tides, induced currents and seawater density differences. The air moving devices utilized to provide the seawater flow are configured to be fish friendly. FIG. 4 is a plan view diagram of a seawater heat source LNG vaporizer with air moving devices. The LNG/propane exchanger 11 is not shown in FIG. 4. Two air moving devices 20 are shown in FIG. 4. They are located above sea level. The air moving devices 20 shown are air fans. The air moving devices can include air fans, blowers, compressors, wave making devices and other air moving devices. The air moving device 20 can provide air flow toward the plate heat transfer surface unit 12, can be configured to provide air flow in the opposite direction or can be configured to provide air flow in either direction. The weather shields 13 shown in FIG. 4 can extend above sea level to help direct the air flow.

FIG. 5 is an elevation view diagram of an air moving device 20 discharging air into a manifold 21. The manifold 21 is arranged to eject air into seawater to provide heat source seawater flow. The air is ejected slightly below sea level. Another manifold arrangement would have air valves or other means to direct air flow in a forward direction or in a reverse direction, thus influencing seawater flow in a forward or reverse direction.

Ocean currents less than 200 meters deep are generally wind source currents. The air flow devices in this patent are utilized to influence seawater flow in a similar manner.

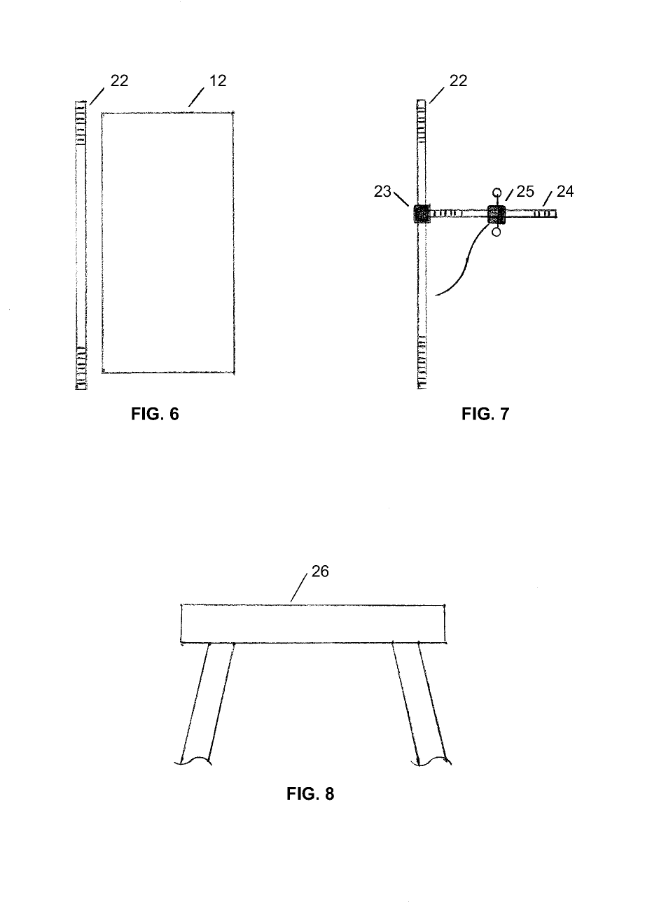

Heat transfer surface area in heat exchange with seawater can become fouled. The plate heat transfer surface unit 12 can be arranged to provide access for physical cleaning of the external plate heat transfer surfaces. FIG. 6 is an elevation view diagram of a plate heat transfer surface unit 12 with vertical cleaner trackage 22. The plate heat transfer surface unit 12 is shown without headers. The vertical cleaner trackage 22 would be attached on plate heat transfer surface units 12 as necessary to provide cleaning for each side of each heat transfer surface unit 12.

Additional details of the cleaning apparatus are shown on FIG. 7. A vertical carriage 23 is positioned on vertical trackage 22 and rides up and down the vertical trackage 22. Vertical carriage 23 includes the drive system for vertical movement. Attached to vertical carriage 23 is horizontal trackage 24. Horizontal trackage 24 moves up and down as propelled by vertical carriage 23. A traveling head 25 rides on horizontal trackage 24. The traveling head 25 can traverse side to side of the plate heat transfer surface unit 12 on horizontal trackage 24. Traveling head 25 includes controls, the drive system for transverse motion, cleaning heads for distributing cleaning fluid, and a connection point for cables and tubing. The horizontal trackage 24 and the traveling head 25 located in the space between adjacent plate heat transfer surface units 12 can clean the heat transfer surface of adjacent plate heat transfer surface units 12. The cleaning apparatus or parts of the apparatus can be temporarily attached and moved about for cleaning or can be permanently positioned.

Another arrangement of the cleaning apparatus would utilize a horizontal carriage positioned on horizontal trackage. The horizontal carriage would traverse side to side on the horizontal trackage. Vertical trackage would be attached to the horizontal carriage. A traveling head similar to traveling head 25 would move vertically up and down the vertical trackage. The cleaning apparatus or parts of the apparatus can be temporarily attached and moved about for cleaning or can be permanently positioned. Alternate surface area cleaning methods can be used.

A manual cleaning wand or system can be used for cleaning the plate heat transfer surface units submerged or the plate heat transfer surface units can be raised for cleaning while out of seawater.

FIG. 8 is an elevation view diagram of an offshore support structure 26 which can be used to support the seawater heat source LNG vaporizer.

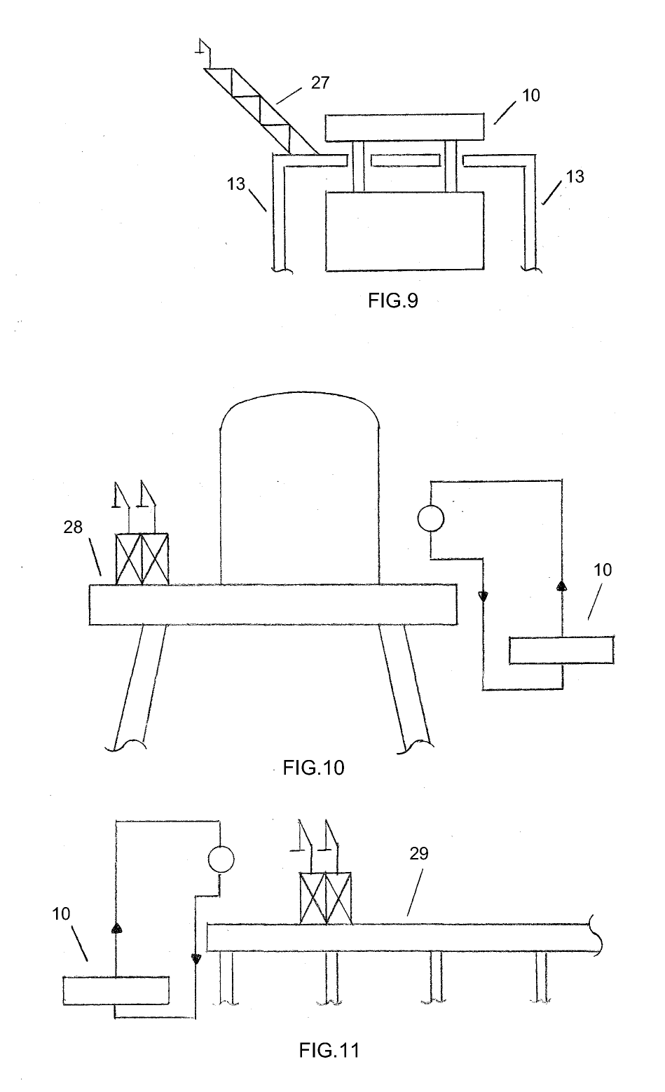

FIG. 9 is an elevation view diagram showing weather shields 13 providing a support structure for the seawater heat source LNG vaporizer 10. A boom 27 can be installed as an option on the support structure. The optional boom 27 can provide support for loading arms or for mooring a LNG ship turret recess or for supporting loading arms and a LNG ship mooring system.

FIG. 10 is an elevation view diagram of an offshore platform 28 supporting seawater heat source vaporizer 10.

FIG. 11 is an elevation view diagram of the end of a jetty 29 supporting a seawater heat source vaporizer 10.

The disclosed invention can include several arrangements and variations. Variations and arrangements can include one of more of the following:
The LNG vapor exiting the vaporizer may require additional heating means before entering natural gas distribution facilities.
The seawater heat source heat exchanger is an arrangement of tubes.
The inlet header propane flow is provided in excess of that vaporized in the plate heat transfer surface unit.
The heat source seawater flow is obtained without seawater pumps.
The propane exiting the plate heat transfer surface unit can include single phase liquid or single phase vapor or two phase flow.
Vaporizing propane can include the heating of propane, the heating and vaporizing of propane, and vaporizing propane.
Vaporizer support structures in addition to those included in the Figures can be provided. The vaporizer can be supported from buoys and single point moorings. The vaporizer can be permanently or temporarily supported.
Various fluids including LNG can be heated and vaporized or vaporized or heated in the vaporizer system.
The LNG vaporizer can include multiple units and multiple components.
The vaporizer can be located to provide LNG vaporization service for floating storage and regasification units (FSRU).
The vaporizer can be located to provide LNG vaporization service for ships.
The vaporizer can be located to provide LNG vaporization service for onshore terminals.
The vaporizer can be located to provide LNG vaporization service for offshore terminals.
The vaporizer can be permanently or temporarily located.
The LNG vaporizer can be the seawater heat source heat exchanger, the LNG/propane exchanger or both.
The vaporizers can use brackish water and river water in addition to seawater as the vaporizer heat source.
The seawater can include particulate matter.
Heat source seawater flow is obtained via natural means, air moving device means and combinations of these.
Seawater pumps can be used in some capacity as part of a vaporizer cleaning system, as part of a cooling system or other uses.

### Objectives Met

The objective of providing a seawater heat source LNG vaporizer which is fish friendly.
Fish species entrainment—entrainment is not an issue with the physical arrangement of the plate heat transfer surface assembly. The elimination of heat source seawater pumps means that fish species are not entrained.
Fish species impingement and impact physical stress—impingement and impact physical stress is not an issue with the physical arrangement of the plate heat transfer surface assembly. The elimination of heat source seawater pumps means that physical stress on fish species is essentially non-existent.
Fish species thermal stress—the plate heat transfer surface assembly wall temperatures in contact with fish are maintained above freezing to reduce fish species thermal stress. The temperature decrease of the heat source seawater as it flows through the plate heat transfer surface assembly is low.
Fish species chemical stress—the system is designed to eliminate the addition of chemicals toxic to fish. The seawater plate heat transfer surface units external heat transfer surfaces can be physical cleaned. The temperature of the external surfaces of the plate heat transfer surface assembly is uniformly cool during operation. Marine growth is reduced. The seawater plate heat transfer surface can be constructed of materials selected to retard marine growth. Portions of the vaporizer can be coated to reduce cleaning requirements.
Fish species oxygen supply—cooler water from vaporization increases fish species oxygen supply.

The objective of providing a seawater heat source LNG vaporizer which has environmental benefits.
Combustion of fuel—using seawater as a heat source reduces the combustion of fuel required as a vaporization heat source. A huge potential source of greenhouse gases is eliminated.
Atmospheric pollution—atmospheric pollution has a major reduction.
Food for marine life—cooler water generally carries more food for marine life.

The objective of providing an energy efficient, high heat transfer rate arrangement to reliably vaporize LNG.
Eliminating the seawater heat source pumps increases the energy efficiency of the vaporizer.
High heat transfer rates are obtained with ice free surfaces.
No exchanger freeze ups increases vaporizer reliability. Having a simple vaporizer arrangement increases vaporizer reliability. The simple control system increases vaporizer reliability.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. The details of the apparatus may be varied substantially without departing from the spirit of the invention, and the exclusive use of all modifications which come within the scope of the appended claims is reserved.

What is claimed:

1. A seawater heat source heat exchanger in heat exchange with seawater, with the heat source seawater not being pumped, where heat source seawater flow is obtained via natural means, air moving device means and combinations of these, and the seawater heat source heat exchanger providing at least a portion of heat for LNG vaporization.

2. The seawater heat source heat exchanger of claim 1, further comprising one or more from the group consisting of:
(a) where the seawater heat source heat exchanger is a plate heat transfer surface unit.
(b) where the seawater heat source heat exchanger is an arrangement of tubes.
(c) where seawater pumps are used for some purpose.
(d) where river water, brackish water and other waters provide a heat source.

3. The seawater heat source heat exchanger of claim 1, where the seawater heat source heat exchanger is fish friendly.

4. A seawater heat source heat exchanger with a seawater side in heat exchange with seawater, and
a fluid side, the heat source seawater flowing generally adjacent to the seawater side, the heat source seawater not being pumped, the fluid side having at least a portion vapor, and the seawater heat source heat exchanger providing at least a portion of heat for LNG vaporization.

5. The seawater heat source heat exchanger of claim 4, further comprising one or more from the group consisting of:
(a) where the seawater heat source heat exchanger is a plate heat transfer surface unit.
(b) where the seawater heat source heat exchanger is an arrangement of tubes.
(c) where seawater pumps are used for some purpose.
(d) where river water, brackish water and other waters provide a heat source.
(e) where the fluid side is all vapor, all liquid or a combination of vapor and liquid.
(f) where heat source seawater flow is obtained via natural means, air moving device means and combinations of these.

6. The seawater heat source heat exchanger of claim 4, where the seawater heat source heat exchanger is fish friendly.

7. A seawater heat source LNG vaporizer comprising:
multiple plate heat transfer surface units containing and vaporizing at least a portion of propane flowing within said plate heat transfer surface units, said plate heat transfer surface units in heat exchange with seawater, seawater flowing generally adjacent to said plate heat transfer surface units, said plate heat transfer surface units providing at least a portion of heat for LNG vaporization;
at least one propane/LNG exchanger providing at least a portion of heat for vaporizing LNG; and
at least one conduit communicating the plate heat transfer surface units with the propane/LNG exchanger, said conduit arranged for propane flow.

8. The seawater heat source LNG vaporizer of claim 7, further comprising one or more from the group consisting of:
(a) where the heat source seawater flow is obtained without seawater pumps.
(b) where heat source seawater flow is obtained via natural means, air moving device means and combinations of these.
(c) where river water, brackish water and other waters provide a heat source.

9. The seawater heat source LNG vaporizer of claim 7, where the seawater heat source LNG vaporizer is fish friendly.

10. A seawater heat source heat exchanger comprising:
plate heat transfer surface units in heat exchange with seawater, said plate heat transfer surface units containing and vaporizing at least a portion of the propane flowing within said plate heat transfer surface units, each plate heat transfer surface unit with at least one unit inlet header and at least one unit outlet header;
at least one propane inlet manifold communicating and distributing propane to said inlet headers;
at least one propane outlet manifold communicating with said unit outlet headers;
at least one propane separator communicating with said propane outlet manifold and providing a separator liquid propane stream and a separator propane vapor stream, said separator propane vapor stream providing at least a portion of heat for LNG vaporization; and
a propane pump communicating with said separator liquid propane stream providing a pump discharge stream, and at least a portion of said pump discharge stream being routed to said propane inlet manifold.

11. The seawater heat source heat exchanger of claim 10, further comprising one or more from the
group consisting of:
(a) where the heat source seawater flow is obtained without seawater pumps.
(b) where heat source seawater flow is obtained via natural means, air moving device means and combinations of these.
(c) where river water, brackish water and other waters provide a heat source.
(d) where inlet header propane flow is provided in excess of that vaporized in the plate heat transfer surface unit.

12. The seawater heat source heat exchanger of claim 10, where the seawater heat source heat exchanger is fish friendly.

13. A plate heat transfer surface cleaning apparatus including trackage, at least one trackage carriage, at least one traveling cleaning head, power and control cables and tubing delivering cleaning material for the cleaning apparatus, wherein the apparatus is configured for cleaning at least a portion of the plate heat transfer surface.
